(19) United States
(12) Patent Application Publication
(10) Pub. No.: US 2008/0261182 A1
(43) Pub. Date: Oct. 23, 2008

(54) Skip-a-space writing and composition paper

(76) Inventor: Brenda Denise (DeBusk) Brotsch, Sweetwater, TX (US)

Correspondence Address: Brenda Denise DeBusk Brotsch, P.O. Box 1, SWEETWATER, TX, 79556, US

(21) Appl. No.: 11/787,437

(22) Filed: Apr. 17, 2007

(51) Int. Cl. G09B 11/00; B42F 13/00

(52) U.S. Cl. 434/162; 281/38; 434/165

(57) ABSTRACT

Writing and composition paper that is functional in helping students to write legibly and teachers to easily read their writing, thus helping teachers make more efficient use of their time. “Skip-A-Space Writing and Composition Paper” is a step above traditional writing paper because it allows students to produce legible handwriting and gives them a “built-in handwriting guide on each sheet of paper”. “Skip-A-Space Writing and Composition Paper” may contain a vertical line approximately one inch from the right and/or left sides of the edge of the paper and may be used for margin guides. A sheet of “Skip-A-Space Writing and Composition Paper” may be wide-ruled or college-ruled. It may also be available in loose leaf or composition notebook form and may contain holes on one side to allow insertion into a binder.

### FIELD OF THE INVENTION

The present invention relates to handwriting paper and, more particularly, to handwriting paper that improves legibility of handwriting.

### BACKGROUND OF THE INVENTION

Students of all ages in educational institutions often write their papers so that the words run together. Students are not able to read their own handwriting. Teachers waste their valuable time trying to decipher the students' papers, and they can be heard saying, “Leave a finger width between your words” or “Leave the width of a pencil between the words you write”. It does not matter how much the teachers tell the students to do this; the words still run together so that there seems to be one long word on each line of the notebook paper. Teachers become frustrated with trying to read the papers that their students write.

Students forget or do not want to take the time to hold their finger or a pencil between each word that they write.

A paper that a student writes may be something like this:

### “LastweekwewenttotheparadeandIsawhorsesandpeoplemarching.Mysisterwasinabandthatplayedattheparade.Itwasrainingandthelighteningwasflashing.Itwasscaryandloud.Ahorsestartedtryingtorunawayandadogstartedbarking.”

This would be even worse with a few misspelled words.

The solution to the problem is “Skip-A-Space Writing and Composition Paper”.

“Skip-A-Space Writing and Composition Paper” is lined writing paper containing individual lines composed of short segments of two alternating colors. Each line is made up of “color 1, color 2, color 1, color 2, color 1, color 2,” etc. If a student writes a word that ends on “color 1”, the student will begin the next word he writes on “color 1”, thus skipping “color 2”. A pencil or a finger is not necessary to “leave a space between words”. Each space is not meant to contain a separate letter but rather as the student writes with his/her usual size handwriting, the spaces are meant to be used as a guide for the amount of space to be skipped between each written word.

It is therefore an object of the invention to provide writing and composition paper that is functional in helping students to write legibly.

It is another object of the invention to provide writing and composition paper that allows students to more easily read their own handwriting.

It is another object of the invention to provide writing and composition paper that helps teachers to easily read students' writings.

It is another object of the invention to provide writing and composition paper that allows teachers to make more efficient use ot their time.

It is another object of the invention to provide writing and composition paper that provides a “built-in handwriting guide” on each sheet of paper.

It is another object of the invention to provide writing and composition paper with a “built-in handwriting guide” that is available in wide-ruled, college-ruled, loose leaf, or composition notebook form.

### SUMMARY OF THE INVENTION

In accordance with the present invention, there is provided writing and composition paper that is functional in helping students to write legibly and teachers to easily read said writing, thus helping teachers make more efficient use of their time. The students will be able to develop good writing habits in an educational setting or as they work at home. “Skip-A-Space Writing and Composition Paper” is a step above traditional writing paper because it allows students to produce legible handwriting and gives them a “built-in handwriting guide on each sheet of paper”. “Skip-A-Space Writing and Composition Paper” may contain a vertical line approximately one inch from the right and/or left sides of the edge of the paper and may be used for margin guides. A sheet of “Skip-A-Space Writing and Composition Paper” may be wide-ruled or college-ruled. It may also be available in loose leaf or composition notebook form and may contain holes on one side to allow insertion into a binder.

### BRIEF DESCRIPTION OF THE DRAWINGS

A complete understanding of the present invention may be obtained by reference to the accompanying drawings, when considered in conjunction with the subsequent, detailed description, in which:

FIG. 1 is a front view of a FIG. 1 shows a front view of the “skip-a-space writing and composition paper” in accordance with the invention;

FIG. 2 is a front detail view of a FIG. 1 shows a front detailed view of the “skip-a-space writing and composition paper” in accordance with the invention. the alternating colors are clearly visible; and

FIG. 3 is a front detail view of a FIG. 3 is a drawing showing how “skip-a-space writing and composition paper” is intended to be used.

For purposes of clarity and brevity, like elements and components will bear the same designations and numbering throughout the Figures.

### DESCRIPTION OF THE PREFERRED EMBODIMENT

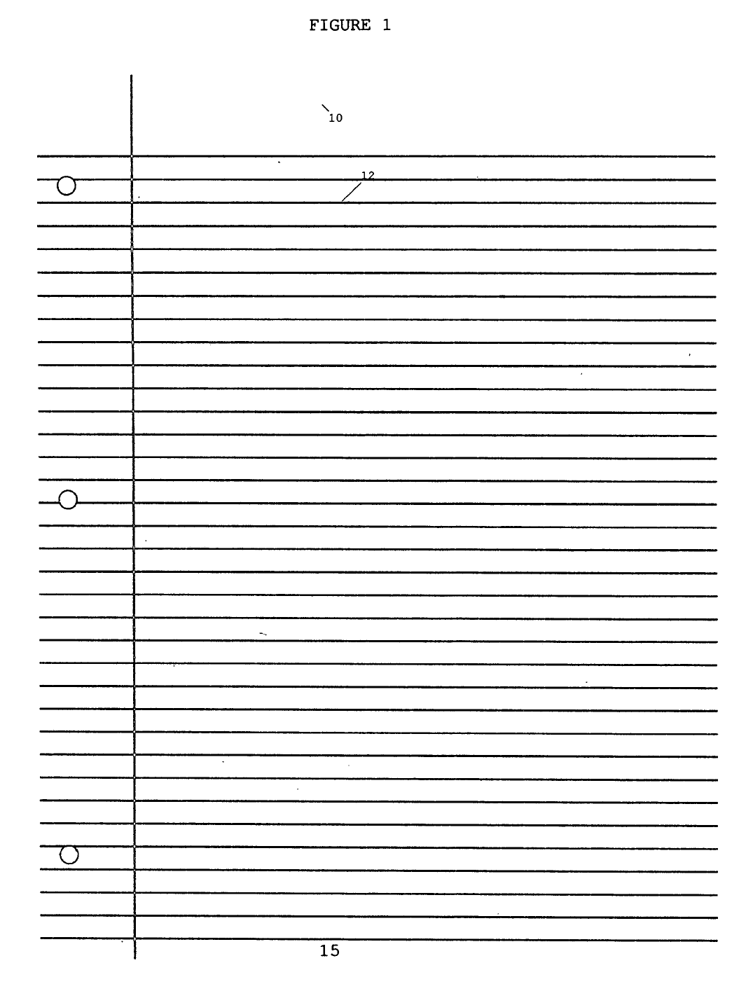

FIG. 1 is a front view of the paper and shows a front view of the “Skip-A-Space Writing and Composition Paper” in accordance with the invention.

The writing/composition paper 10 is the surface for writing. This paper could be college-ruled, wide-ruled, loose leaf, or spiral-bound.

The lines on composition paper printed in alternating colors on each line 12 are a necessary element of Skip-A-Space writing and composition paper. The lines of alternating colors are the distinguishing feature of the invention and set “Skip-A-Space Writing and Composition Paper” apart from other writing and composition papers. The lines of alternating colors provide a built-in guide for handwriting. They occur on each line of the writing/composition paper 10.

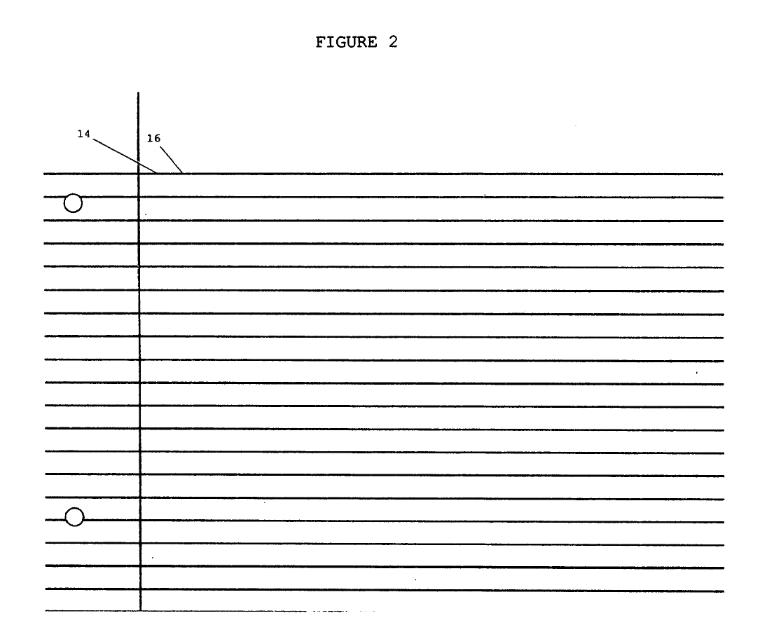

FIG. 2 is a front detail view of the writing/composition paper 10 and shows a front detailed view of the “Skip-A-Space writing and composition paper” in accordance with the invention. The alternating colors are clearly visible.

Color 1 14 is the first color printed on each line of the writing/composition paper 10.

Color 2 16 is the second color printed on each line of the writing/composition paper 10.

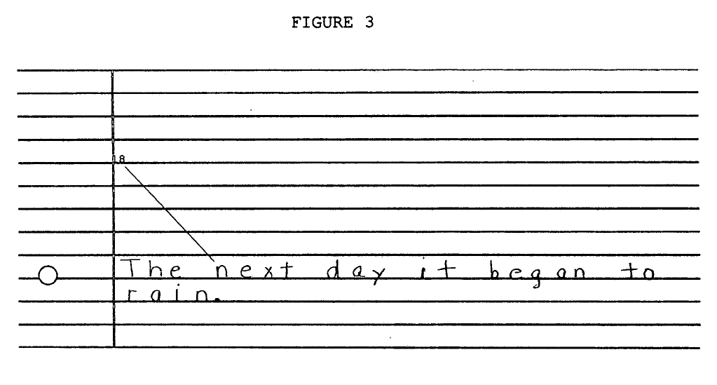

FIG. 3 is a drawing includes sample handwriting 18 showing how Skip-A-Space Writing and Composition Paper is intended to be used. The student will write in his/her usual size of handwriting on the writing/composition paper 10. It is demonstrated that when the first word written by the student ends on color 1 14, the following word written by the student begins on the next color 1 14. It is also demonstrated that when a word written by the student ends on color 2 16, the following word written by the student begins on the next color 2 16

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Having thus described the invention, what is desired to be protected by Letters Patent is presented in the subsequently appended claims.

What is claimed is:

1. A skip-a-space writing and composition paper for improving and clarifying legibility of handwriting, comprising:
means for allowing a student a surface for writing;
means for giving the student a “built-in handwriting guide”;
means for providing a “built-in handwriting guide” on each line of the “skip-a-space writing and composition paper”; and
means for providing a “built-in handwriting guide” on each line of the “skip-a-space writing and composition paper”.

2. The skip-a-space writing and composition paper in accordance with claim 1, wherein said means for allowing a student a surface for writing comprises a writing/composition paper writing/composition paper.

3. The skip-a-space writing and composition paper in accordance with claim 1, wherein said means for giving the student a “built-in handwriting guide” comprises a color 1, color 2 lines on composition paper printed in alternating colors on each line.

4. The skip-a-space writing and composition paper in accordance with claim 1, wherein said means for providing a “built-in handwriting guide” on each line of the “skip-a-space writing and composition paper” comprises a color 1 color 1.

5. The skip-a-space writing and composition paper in accordance with claim 1, wherein said means for providing a “built-in handwriting guide” on each line of the “skip-a-space writing and composition paper” comprises a color 2 color 2.

6. A skip-a-space writing and composition paper for improving and clarifying legibility of handwriting, comprising:
a writing/composition paper writing/composition paper, for allowing a student a surface for writing;
a color 1, color 2 lines on composition paper printed in alternating colors on each line, for giving the student a “built-in handwriting guide”;
a color 1 color 1, for providing a “built-in handwriting guide” on each line of the “skip-a-space writing and composition paper”; and
a color 2 color 2, for providing a “built-in handwriting guide” on each line of the “skip-a-space writing and composition paper”.

7. A skip-a-space writing and composition paper for improving and clarifying legibility of handwriting, comprising:
a writing/composition paper writing/composition paper, for allowing a student a surface for writing;
a color 1, color 2 lines on composition paper printed in alternating colors on each line, for giving the student a “built-in handwriting guide”;
a color 1 color 1, for providing a “built-in handwriting guide” on each line of the “skip-a-space writing and composition paper”; and
a color 2 color 2, for providing a “built-in handwriting guide” on each line of the “skip-a-space writing and composition paper”.
